(19) United States
(12) Patent Application Publication
(10) Pub. No.: US 2007/0192381 A1
(43) Pub. Date: Aug. 16, 2007

(54) Recalling website customer information across multiple servers located at different sites not directly connected to each other without requiring customer registration

(76) Inventor: Arun K. Padmanabhan, Uniondale, NY (US)

Correspondence Address: Thomas M. Galgano, Esq.;GALGANO & ASSOCIATES, PLLLC, Suite 204, 20 West Park Avenue, Long Beach, NY, 11561, US

(21) Appl. No.: 11/355,225

(22) Filed: Feb. 15, 2006

(51) Int. Cl. G06F 17/30

(52) U.S. Cl. 707/201

(57) ABSTRACT

According to a first aspect of the invention SQL (structured query language) statements are sent from one server to another so that customer databases are synchronized. As SQL statements are generated, they are added to a table and flagged as new. At regular intervals, new formatted SQL statements together with their time stamps are transferred to the other server(s) via messaging, ftp or http. When the statements are received, they are executed in timestamp order. This causes all of the server data base(s) to be synchronized with each other. After a statement has been sent out to other servers, its new flag is changed so that it is not sent more than once. According to a second aspect of the invention, a “clear pixel call” is encoded into every shopping related page of the seller's website on every server. More particularly, each page contains a clear pixel call to each of the other servers. The clear pixel call also sends current shopper's ID to the remote server. In the part of the call that specifies the remote image file, a remote active server page (.asp) or java server page (.jsp) is indicated. When remote asp or jsp page receives the call, it takes the shopper ID which accompanied the call and writes a cookie with the ID to the customer's computer.

### BACKGROUND OF THE INVENTION

1. Field of the Invention

This invention relates broadly to e-commerce. More particularly, this invention relates to methods and apparatus for recalling customer information over multiple web servers which are located at different locations and not directly connected to each other without requiring the customer to register at a web site.

2. State of the Art

Many commercial websites offer customers the opportunity to (or require them to) register before shopping at the website. Registration has the benefit that shopping can be expedited. After a customer has registered and received a user ID and password, the customer's credit card and shipping information are stored at the commercial website. When the customer comes to the website to shop, the customer logs in. When the customer is finished shopping, check-out is nearly automatic and the customer does not need to re-enter payment and shipping information. The payment and shipping information is retrieved from storage at the website based on the user ID. The log in process can also be automated through the use of “cookies”. A cookie is a small text file that is created by the website and is stored on the customer's computer. When a customer goes to a website, the website software reads the cookie on the customer's computer and immediately knows who the customer is. Cookies and or customer log in procedures also have the advantage of remembering the contents of a shopper's shopping cart. For example, sometimes a customer may be shopping at a website, adding items to a virtual shopping cart and then needs to discontinue shopping unexpectedly before checking out. If the customer is registered with the website and was logged in (either manually or automatically via a cookie) when the shopping session is interrupted, the website can store the contents of the shopping cart in a local database. When the customer returns to the website, the site software will retrieve shopping cart data based on user ID and the shopping cart will contain all of the items that were in it when the last shopping session was interrupted.

Although registration at a commercial website provides advantages, there are reasons for not registering at a commercial website. One reason for not registering is if the customer knows or believes that they will not be returning to this site to shop again. Another reason is a perceived security risk. Some customers may perceive that by registering, their credit card information is at risk of theft. For these two reasons alone, many commercial website transactions are anonymous up until the time of check out when the customer enters payment and shipping information.

When a customer goes to a commercial website to shop and the customer has not previously registered with the site, the software at the site does not know the identity of the customer until check out. Although the customer is “unknown” to the seller, it is advantageous that the seller maintain some record of the contents of the customer's shopping cart in case the shopping session is interrupted. This way, should the customer return to complete the shopping session, the customer will find the shopping cart as it was when the first session was interrupted. In many instances this can be accomplished through the use of a cookie. When an anonymous customer goes to a shopping website, the software at the site assigns the customer a unique ID and writes that ID to a cookie on the customer's computer. Whenever the customer returns to the site, the cookie is read and the software at the site can identify the customer as the customer that was assigned that customer number on a previous occasion. This method can be used to remember the contents of an anonymous customer's shopping cart when a shopping session is interrupted. However, this method has one potentially serious limitation.

The nature of a cookie is such that it can only be read by software residing at the same domain as the software that created the cookie. For example, a cookie placed on a customer's computer by software at www.myinternetstore.com cannot be read by software residing at www.yourinternetstore.com. For many small businesses, this is not a problem because their website resides on a single server at a single domain. However, this can be a serious problem for larger businesses that have many daily customers.

Large commercial websites that have many customers visit every day need to have more than one server and each of these servers may have a slightly different domain name. Also servers may be located in different places and not directly connected to each other. When a customer directs their browser to the commercial website domain, the customer's browser connects to a “global load balancer”. The load balancer then decides which of the several servers the customer will be connected to. If a customer's anonymous shopping session is interrupted, there is no guarantee that the load balancer will connect the customer to the same server when the customer returns. A cookie written by one of the servers cannot be read by a different server in a different domain. Thus, if the customer returns and is connected to a different server, the shopping cart contents are not remembered. Moreover, even if all of the seller's servers could read cookies written by any one of the seller's servers, the shopping cart data still only resides on the server at the location to which the customer was last connected.

In cases where a customer has registered and logs in to a server with a user ID, customer data generated at a different server still needs to be copied to the other servers. Each website has its own data store, commonly a relational database management systems (RDMS). Data is transferred among data stores by one of two approaches: Either the database log files from the initial site are sent via messaging, ftp (file transfer protocol) or http (hypertext transfer protocol) to the remote site(s) or large amounts of data are sent in a similar manner. These log files or data are then applied to the remote data stores. There are problems with either approach. In the case of log shipping, there is a significant time delay due to the time required to apply the log. This time, commonly in the range of ten to fifteen minutes, means that the remote site(s) will not have up-to-date information if the user's interaction with the primary site is disrupted and the user is redirected to a remote site. The second approach of sending all the information in the primary site over to the remote site(s) and applying it also requires sending large amounts of information across the seller's network, requiring expensive network infrastructure as well as leading to time delays in the availability of the data at the remote site(s).

### SUMMARY OF THE INVENTION

It is therefore an object of the invention to provide methods and apparatus for recalling website customer information.

It is another object of the invention to provide methods and apparatus for recalling website customer information without requiring customer registration.

It is a further object of the invention to provide methods and apparatus for recalling website customer information over multiple servers residing in different domains without requiring customer registration.

It is also an object of the invention to provide methods and apparatus for copying customer information from one server to another.

It is an additional object of the invention to provide methods and apparatus whereby cookie information written by one server in one domain can be read by another server in a different domain.

In accord with these objects, which will be discussed in detail below, the present invention provides new and efficient ways to transfer customer information and to enable anonymous customers to be identified by cookies even when the customer is redirected to a different server. According to a first aspect of the invention SQL (structured query language) statements are sent from one server to another so that customer databases are synchronized. The SQL statements are normally generated by customer interaction with a website and these statements are used to create, delete, or modify database information. As SQL statements are generated, they are added to a table and flagged as new. At regular intervals, new formatted SQL statements together with their time stamps are transferred to the other server(s) via messaging, ftp or http. When the statements are received, they are executed in timestamp order. This causes all of the server data base(s) to be synchronized with each other. After a statement has been sent out to other servers, its new flag is changed so that it is not sent more than once. According to a second aspect of the invention, a procedure normally used to increment page counters is used to replicate cookie information among a group of servers. A “clear pixel call” (a call to a remote site to retrieve an image consisting of a single pixel) is encoded into every shopping related page of the seller's website on every server. More particularly, each page contains a clear pixel call to each of the other servers. The clear pixel call also sends current shopper's ID to the remote server. In the part of the call that normally specifies the remote image file, a remote active server page (.asp) or java server page (.jsp) is indicated. This is followed by a question mark and a variable identification, e.g. http:www.imagelocation.com?ShopperId=123456789). When remote asp or jsp page receives the call, it takes the shopper ID which accompanied the call and writes a cookie with the ID to the customer's computer.

If the customer's session with one server is interrupted for any reason and the customer is directed to a different server, the different server will find a cookie associated with it on the customer's computer providing the different server with the customer's ID. In addition, since the SQL statements have been copied from server to server, the customer data such as contents of shopping cart will be the way they were when the customer left the first server.

Additional objects and advantages of the invention will become apparent to those skilled in the art upon reference to the detailed description taken in conjunction with the provided figures.

### BRIEF DESCRIPTION OF THE DRAWINGS

FIG. 1 is an SQL table according to the invention;

FIG. 2 is a schematic diagram illustrating the flow of information during cookie cloning according to the invention; and

FIG. 3 is a high level flow chart illustrating the processes of the invention.

### BRIEF DESCRIPTION OF THE APPENDIX

The attached CDROM appendix includes source code for implementing portions of the invention. The CDROM is in ISO 9660 format and contains the following files:

| Name | Size | | Last Modified |
|---|---|---|---|
| cscriptr.exe | 120 | bytes | October 5, 2005 1:44 PM |
| shop.asp | 7,428 | bytes | October 5, 2005 1:33 PM |
| basketre.vbs | 24,082 | bytes | October 5, 2005 1:46 PM |
| cscriptt.exe | 295 | bytes | October 5, 2005 1:38 PM |
| cookiecl.asp | 22,302 | bytes | October 5, 2005 1:46 PM |
| baskettr.vbs | 29,796 | bytes | October 5, 2005 1:42 PM |

### DETAILED DESCRIPTION

When a customer interacts with a commercial website, SQL statements are generated. These statements create or modify database entries. For example, when an anonymous customer begins to interact with the site, the customer is assigned an ID. An exemplary SQL statement assigning a customer ID is: UPDATE register SET process_flag=‘P’ WHERE registerid=‘W000410612071’. This ID is sent in a cookie to the customer's computer. The statement to send the cookie has the general form: <set-cookie>name time domain value path<set-cookie/>. Name is the name of the cookie. Time is how long the cookie will be kept which can be anywhere from one second to five years. Domain is the domain for which the cookie is valid. Value is, in this example, the customer ID. Path is the path in which the cookie should be available.

SQL statements are also generated when the website is altered. For example, the following statement alters the description of a product collection: UPDATE product_collection SET description=.‘June Favorites’,image_name=‘AX345’, image_on=‘N’,collection_image=“,start_date=null,end_date=‘6/30/2005 10:45’,active_flag=‘Y’, Corporate_Description=‘ ’,Corporate_Link=‘’,siteId=‘FLWS’,page_title_override=‘N’.

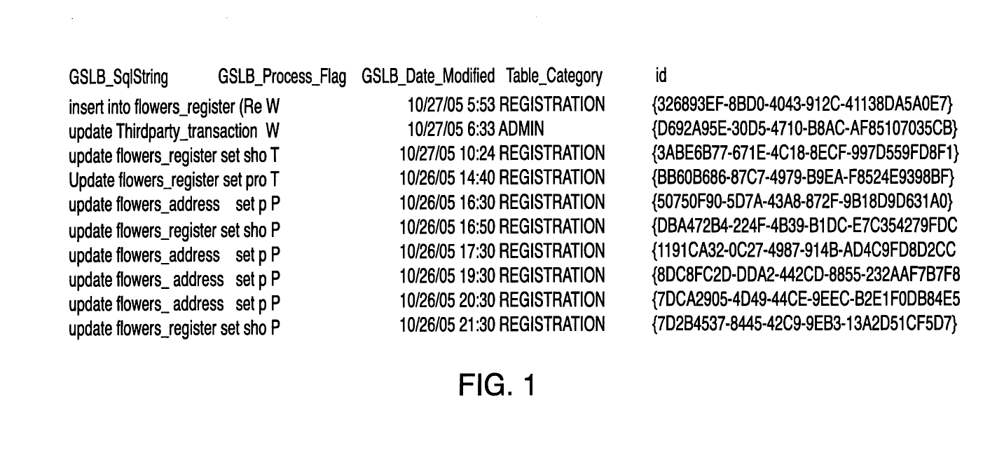

According to one aspect of the invention, as SQL statements are generated and processed, copies of the statements are stored in a table such as the table shown in FIG. 1. The table has five columns: GSLB_SqlString, GSLB_Process_Flag, GSLB_Date_Modified, Table_Category, and Id. GSLB_SqlString contains a copy of the actual SQL statement. GSLB_Process_Flag contains a flag indicating that the SQL statement needs to be copied to other servers. According to the presently preferred embodiment there are three flag values: W (waiting) indicates a row waiting to be sent to remote servers, T (transmitted) indicates that the row was sent to remote servers, and P (processed) indicates that the row was received and processed by the remote server(s). GSLB_Date_Modified includes the date and time the table entry was made. Table_Category indicates whether the statement is related to customer registration or web site administration. Id is a unique identifier for the table entry.

According to another aspect of the invention, the table entries are scanned at regular intervals, e.g. every ten seconds. For every table entry containing a W flag, the GSLB_SqlString together with its corresponding GSLB_Date_Modified timestamp is transmitted to the other servers and the W flag is changed to T for transmitted. A visual basic script for accomplishing the table scan, transmission and flag setting is included in the appendix file baskettr.vbs. Those skilled in the art will appreciate that the filenames on the CDROM appendix were truncated by the ISO formatting which limits filename length. The actual filename should be basket_transmit.vbs. The file cscriptt.exe launches the basket_transmit.vbs script. Then the statements and timestamps are received at the remote servers another script basket_receive.vbs (basketre.vbs) processes the statements in timestamp order with respect to its local database. The file cscriptr.exe launches the script basket_receive.vbs.

The process described above keeps all of the server's databases synchronized so that if a customer starts filling a shopping cart while connected to one server, leaves and returns to be connected to another server, the second server will have access to the same shopping cart information. However, the second server still has no way of matching the shopping cart with the anonymous customer. The cookie placed on the customer's computer by the first server cannot be read by the second server.

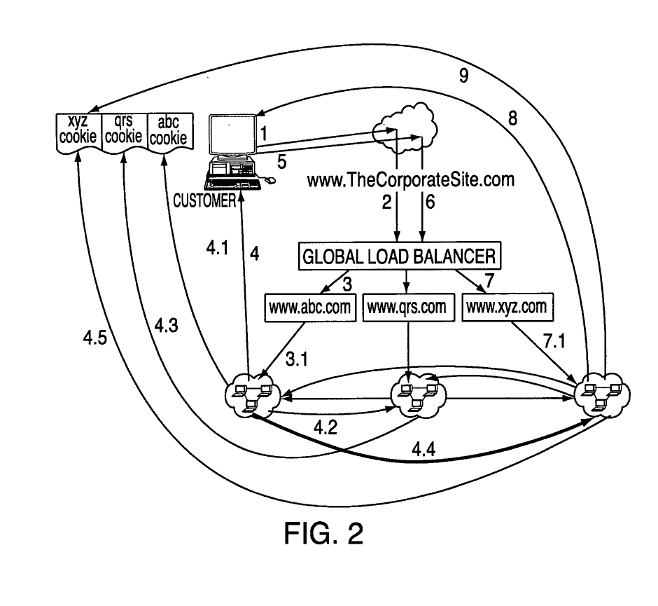

FIG. 2 and the appendix source code in file shop.asp and cookiecl.asp (cookieCloner.asp) illustrate how cookie information is exchanged among servers so that a customer ID assigned by one server can be recognized by all the servers. In FIG. 2, a customer computer connects to the internet at 1 and then to the commercial website's load balancer at 2. The load balancer selects one of three servers (www.abc.com) at 3 and the customer begins to interact with the server at www.abc.com at 3.1 and 4. Every interactive page on the www.abc.com server includes the code shop.asp. This code, which is an active-x server page, looks for a cookie on the customer's computer. If one is found, the customer ID is retrieved. If none is found, a customer ID is created (the code uses the term ShopperID) and a cookie is sent to the customer's computer at 4.1. The following code creates a customer cookie:

```
select
  case cloneType
  case “shopper”
    ReqShopperID=Request(“ShopperID”)
    Set MSCSSite = Application(“MSCSSite”)
    if IsObject(mscsPage) = FALSE then
    Set mscsPage = Server.CreateObject(“Commerce.Page”)
    end if
    if NOT IsNull(ReqShopperID) then
    Call mscsPage.PutShopperId(ReqShopperID)
    Response.Cookies(“NP”) = “2”
    Response.Cookies(“NP”).Expires = DateAdd(“YYYY”, 10, Now( ))
    end if
```

In addition, each interactive page on the www.abc.com site includes the following two html statements:

<img src=http://www.qrs.com/include/cookieCloner.asp? shopperid=E6U25FLT7PTA9KEM2SH4VFX3U39N11F1 cloneType=shopper height=1 width=1 border=0>, and

<img src=http://www.xyz.com/include/cookieCloner.asp? shopperid=E6U25FLT7PTA9KEM2SH4VFX3U39N11F1 cloneType=shopper height=1 width=1 border=0>.

These html statements ostensibly call for images to be retrieved from the other two servers shown in FIG. 2. However, the designated image is actually the cookieCloner.asp code which is stored on every server. The part of the statement following the “?” is a parameter which is passed to the cookiecloner.asp code. These statements cause the code in cookieCloner.asp to be run on each of the other servers. For example, the first statement calls to server www.qrs.com as illustrated by the arrow 4.2 in FIG. 2. Execution of the code in cookieCloner.asp on the server at www.grs.com causes a cookie to be sent to the customer from the server at www.qrs.com as illustrated at 4.3 in FIG. 2. The second statement calls to the server at www.xyz.com at 4.4 and results in a cookie being sent from the server at www.xyz.com to the customer as illustrated at 4.5

The customer interrupts the session and reconnects at 5 and 6 in FIG. 2 and is this time connected at 7 and 7.1 to a different server. Since the cookie placed by the first server has been cloned for this server, this server is able to identify the customer by retrieving the cookie at 8 and 9.

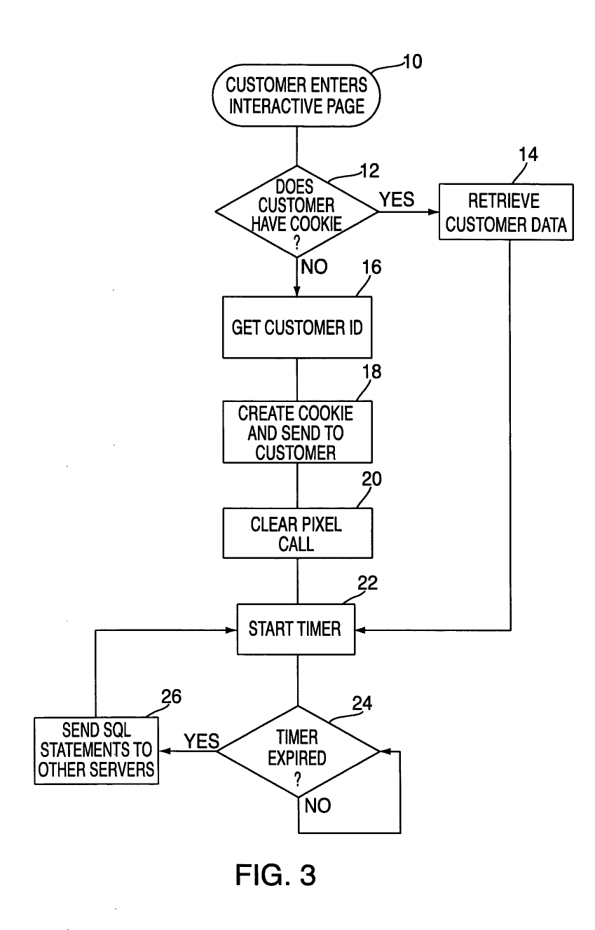

FIG. 3 illustrates an overview of the functions of the invention. Starting at 10 a customer enters an interactive page of the commercial web site. The website software looks on the customer's computer at 12 for a cookie. If there is no cookie, a customer ID is assigned at 16. A cookie is created and sent to the customer at 18. The clear pixel call is executed at 20 for each additional server, thereby cloning the cookie. A timer is set at 22 and when the timer expires at 24, copies of SQL statements are sent to the other servers at 26. The timer is then reset at 22. If the customer already had a cookie as determined at 12, the cookie data is retrieved at 14 and the timer is set at 22.

There have been described and illustrated herein methods for recalling website customer information in the presence of multiple servers without requiring customer registration. While particular embodiments of the invention have been described, it is not intended that the invention be limited thereto, as it is intended that the invention be as broad in scope as the art will allow and that the specification be read likewise. It will therefore be appreciated by those skilled in the art that yet other modifications could be made to the provided invention without deviating from its spirit and scope as claimed.

What is claimed is:

1. A method for synchronizing databases on multiple servers, said method comprising:
storing database change statements in a table at one server; and
periodically transmitting said statements to another server.

2. The method according to claim 1, wherein:
said servers are in different physical locations and not directly connected to each other.

3. The method according to claim 2, wherein:
said servers are in different domains.

4. The method according to claim 1, further comprising:
flagging each statement to indicate whether it has been transmitted to another server and whether another server has received it.

5. The method according to claim 1, wherein:
each statement is stored with a timestamp.

6. The method according to claim 5, further comprising:
receiving statements at a server and executing received statements in timestamp order.

7. A method of replicating cookie information so that it can be retrieved by multiple servers, said method comprising:
upon generating a cookie at one server, sending cookie information to a second server; and
generating another cookie at said second server.

8. The method according to claim 7, wherein:
said step of sending cookie information includes a clear pixel call.

9. The method according to claim 8, wherein:
said clear pixel call references a java server page.

10. The method according to claim 8, wherein:
said clear pixel call references an active server page.

11. A method for recalling website customer information in the presence of multiple servers without requiring customer registration, comprising:
at a first server, generating a customer cookie and sending cookie information to a second server;
at said first server, recording customer generated database statements and periodically transmitting said statements to said second server.

12. The method according to claim 11, wherein:
said step of sending cookie information includes a clear pixel call.

13. The method according to claim 12, wherein:
said clear pixel call references a java server page.

14. The method according to claim 12, wherein:
said clear pixel call references an active server page.

15. The method according to claim 11, further comprising:
flagging each statement to indicate whether it has been transmitted to said second server and whether said second server has received it.

16. The method according to claim 11, wherein:
each statement is recorded with a timestamp.

17. The method according to claim 16, further comprising:
receiving statements at said second server and executing received statements in timestamp order.

18. An apparatus for recalling website customer information in the presence of multiple servers without requiring customer registration, comprising:
at a first server, means for generating a customer cookie and means for sending cookie information to a second server;
at said first server, means for recording customer generated database statements and means for periodically transmitting said statements to said second server.

19. The apparatus according to claim 18, wherein:
said means for sending cookie information includes means for sending a clear pixel call.

20. The apparatus according to claim 19, wherein:
said clear pixel call references a java server page.

21. The apparatus according to claim 19, wherein:
said clear pixel call references an active server page.

22. The apparatus according to claim 18, further comprising:
means for flagging each statement to indicate whether it has been transmitted to said second server and whether said second server has received it.

23. The apparatus according to claim 18, wherein:
each statement is recorded with a timestamp.

24. The apparatus according to claim 23, further comprising:
means for receiving statements at said second server and means for executing received statements in timestamp order.

25. An apparatus for synchronizing databases on multiple servers, said apparatus comprising:
means for storing database change statements in a table at one server; and
means for periodically transmitting said statements to another server.

26. The apparatus according to claim 25, further comprising:
means for flagging each statement to indicate whether it has been transmitted to another server and whether another server has received it.

27. The apparatus according to claim 25, wherein:
each statement is stored with a timestamp.

28. The apparatus according to claim 27, further comprising:
means for receiving statements at a server and means for executing received statements in timestamp order.

29. An apparatus for replicating cookie information so that it can be retrieved by multiple servers, said apparatus comprising:
means for generating a cookie at one server;
means for sending cookie information to a second server; and
means for generating another cookie at said second server.

30. The apparatus according to claim 29, wherein:
said means for sending cookie information includes means for sending a clear pixel call.

31. The apparatus according to claim 30, wherein:
said clear pixel call references a java server page.

32. The apparatus according to claim 30, wherein:
said clear pixel call references an active server page.
